(19) United States
(12) Patent Application Publication
(10) Pub. No.: US 2016/0350240 A1
(43) Pub. Date: Dec. 1, 2016

(54) SERIAL PERIPHERAL INTERFACE HOST PORT

(71) Applicant: ANALOG DEVICES GLOBAL, Hamilton (BM)

(72) Inventors: Richard F. Grafton, Abington, MA (US); Shivakumar Patil, Bangalore (IN); James Potts, Wellesley, MA (US); Lewis F. Lahr, Dover, MA (US)

(73) Assignee: ANALOG DEVICES GLOBAL, Hamilton (BM)

(21) Appl. No.: 14/726,190

(22) Filed: May 29, 2015

(51) Int. Cl. G06F 13/16; G06F 13/42

(52) U.S. Cl. CPC G06F 13/1668; G06F 13/4282

(57) ABSTRACT

A serial peripheral interface (SPI) host port is disclosed that enables a host external to a processor to access the processor's memory-mapped resources using SPI memory command protocol. An exemplary processor can include a system interconnect connected to memory-mapped resources and a SPI host port connected to the system interconnect. The SPI host port is configured to use SPI memory command protocol to access memory-mapped resources of the processor for the host external to the processor.

### TECHNICAL FIELD

The present disclosure relates generally to processors, and more particularly, to a serial peripheral interface that provides slave support for accessing memory-mapped resources of a processor.

### BACKGROUND

An electronic system can combine different processors (including microprocessors, microcontrollers, digital signal processors, central processing units, or other type of processor) with circuitry to achieve specific applications. One processor, typically referred to as a host processor, may control operations of another processor, typically referred to as a slave processor. For example, a general purpose processor may control general operations of the electronic system, along with operations of an application-specific processor that performs application-specific operations (such as a digital signal processor performing specific signal processing operations under control of the general purpose processor). A host interface may be implemented to connect the host processor and the slave processor, which allows communication between the host processor and the slave processor. Processors today demand lightweight, low expense, low performance host interfaces that enable the host processor to access resources of the slave processor. Although existing host interfaces, such as parallel host port interfaces, have been generally adequate for their intended purposes, they have not been entirely satisfactory in all respects.

### BRIEF DESCRIPTION OF DRAWINGS

The present disclosure is best understood from the following detailed description when read with the accompanying figures. It is emphasized that, in accordance with the standard practice in the industry, various features are not drawn to scale and are used for illustration purposes only. In fact, the dimension of the various features may be arbitrarily increased or reduced for clarity of discussion.

FIG. 1 is a schematic block diagram of an exemplary processing system that includes a serial peripheral interface that supports access to memory-mapped resources of the processing system by a host external to the processing system according to various aspects of the present disclosure.

FIG. 2 is an exemplary master to slave connection model between serial peripheral interface, such as the processing system of FIG. 1, and a host external to the processing system according to various aspects of the present disclosure.

FIGS. 3A-3E depict exemplary serial peripheral interface host port registers, which can be implemented in the processing system of FIG. 1, according to various aspects of the present disclosure.

FIG. 4A is a flowchart of an exemplary method that can be performed to enable a host external to a processor, such as the processing system of FIG. 1, to access memory-mapped resources according to various aspects of the present disclosure.

FIG. 4B is a flowchart of an exemplary method that can be performed by a host external to a processor, such as the processing system of FIG. 1, to access memory-mapped resources according to various aspects of the present disclosure.

### OVERVIEW OF EXAMPLE EMBODIMENTS

A serial peripheral interface (SPI) host port is disclosed that enables a host external to a processor to access the processor's memory-mapped resources using SPI memory command protocol. The SPI host port enables the processor to operate as a slave and the host to operate as a master that controls data transfer between the processor and the host.

An exemplary processor can include a SPI host port connected to a system interconnect, which is connected to memory-mapped resources. The SPI host port is configured to use an SPI memory command protocol, such as a SPI SRAM/Flash style protocol, to access memory-mapped resources of the processor for a host external to the processor. In various implementations, the SPI host port can interpret a payload of an SPI communication packet received from the host as an access instruction and perform an access operation based on the access instruction, wherein the SPI communication packet is based on the SPI memory command protocol. The SPI host port can include a system master interface connected to the system interconnect that is configured to access the memory-mapped resources across the system interconnect based on the access instruction. In some implementations, the system master interface can interpret the SPI communication packet based on the SPI memory command protocol into the access instruction.

The SPI host port can include a SPI host port ready line for asserting an SPI host port ready signal to the host when the SPI host port is ready to perform an access operation. A SPI host port status register can include a SPI host port status ready bit that indicates when the SPI host port is ready to perform an access operation. In some implementations, the SPI host port status register includes an error condition bit that indicates an error condition.

The SPI host port can include a SPI host port interrupt request line for asserting a SPI host port interrupt request signal when the SPI host port detects an error condition, and/or a SPI host port trigger out line for asserting a SPI host port trigger out signal when the SPI host port is ready to perform an access operation. In some implementations, the SPI host port interrupt request line is connected to a system event controller of the processor. A SPI host port control register can include an error condition mask bit for controlling assertion of the SPI host port interrupt request signal. In some implementations, the SPI host port trigger out line is connected to a trigger routing unit of the processor. A SPI host port control register that includes a trigger mode bit for controlling a source for asserting the SPI host port trigger out signal.

### DETAILED DESCRIPTION OF EXAMPLE EMBODIMENTS

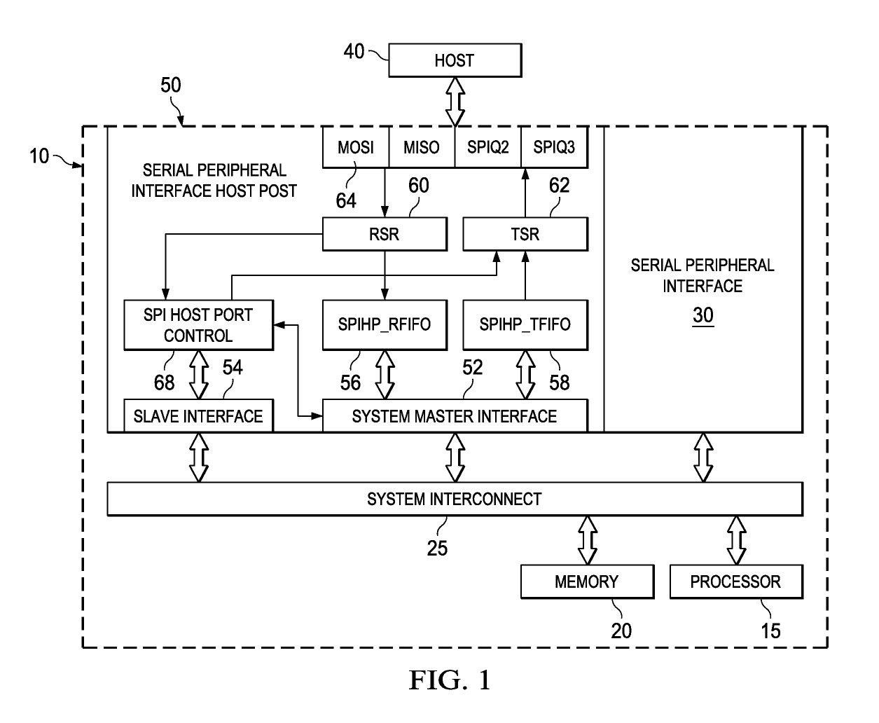

A serial peripheral interface is disclosed that can be implemented by a processor to provide a lightweight, low cost, low performance interface for providing a host external to a processor control and access of the processor's memory-mapped resources. FIG. 1 is a schematic block diagram of an exemplary processing system 10 that includes a serial peripheral interface that supports access to memory-mapped resources of the processing system by a host external to the processing system according to various aspects of the present disclosure. In various implementations, processing system 10 is an embedded processor, for example, from Analog Devices, Inc.'s family of Blackfin+® (ADSP-BF7xx) processors. Processing system 10 may be a microprocessor, digital signal processor, microcontroller, central processing unit, system-on-chip, or other processor depending on design requirements. FIG. 1 has been simplified for the sake of clarity to better understand the inventive concepts of the present disclosure. Additional features can be added in processing system 10, and some of the features described can be replaced or eliminated in other embodiments of processing system 10.

Processing system 10 includes a processor 15 and a memory 20. Processor 15 may be referred to as a core processor, which may be implemented as a central processing unit (CPU), a microcontroller, a microprocessor, a digital signal processor, or other processor. Memory 20 can include a flash memory, a random access memory (RAM), a read only memory (ROM), a dynamic RAM (DRAM), a static RAM (SRAM), a synchronous DRAM (SDRAM), a double data rate SDRAM (DDR SDRAM), a graphic DDR memory, a magnetoresistive RAM (MRAM), other type of memory, or combination thereof.

A system interconnect 25 interconnects various components of processing system 10. For example, in the depicted embodiment, processor 15 and memory 20 are coupled to system interconnect 30, such that processor 15 and memory 20 can communicate with one another via the system interconnect 25. Memory-mapped resources (which includes memory 20) are connected to system interconnect 25, where each memory-mapped resource has a defined, unique address (a memory-mapped address). Memory-mapped resources can include memory, internal and/or external to processing system 10, and memory-mapped registers, such as control registers and data registers associated with various components of processing system 10. System interconnect 25 can include a single bus, multiple buses, a crossbar network, a single-stage network, a multistage network, other type of interconnection network, or combination thereof. In various implementations, system interconnect 25 can implement system crossbars (SCB) that form a switch-fabric style for system bus interconnection.

A serial peripheral interface (SPI) 30 connected to system interconnect 25 enables communication between processing system 10 and SPI-compatible devices external to processing system 10. In FIG. 1, a host 40 external to processing system 10 can connect to and communicate with processing system 10 through SPI 30. SPI 30 can be implemented as a full-duplex, four wire synchronous serial interface based on a master/slave relationship. SPI 30 is configured to serially transmit and receive data to/from processing system 10 and SPI-compatible devices external to processing system 10. For example, SPI 30 can have a four-wire interface that includes two data lines (for facilitating full-duplex operation), a device select line, and a clock line. Two additional data lines can be implemented to facilitate quad SPI operation. During SPI data transfer, data is simultaneously transmitted (for example, shifted out serially) and received (for example, shifted in serially) on the data lines, and a serial clock line synchronizes shifting and sampling of information on the data lines.

Typically, SPI 30 simply transfers data between processing system 10 and host 40 (for example, by moving data in/out of first-in-first out memory buffers), where host 40 has no control over the data transfer. The present disclosure proposes extending SPI 30 to include a mechanism that allows host 40 to control SPI data transfer between host 40 and processing system 10. Such control can facilitate host 40 directly accessing memory-mapped resources, such as memory and/or memory-mapped registers, of processing system 10. In FIG. 1, SPI 30 is extended with a SPI host port 50 connected to system interconnect 25 that provides a slave interface for processing system 10, enabling processing system 10 to operate as a slave and host 40 (a host external to processing system 10) to operate as a master that controls data transfer between processing system 10 and host 40. In various implementations, host 40 can master access operations associated with memory-mapped resources of processing system 10. During SPI data transfer, host 40 operates as a master device, and processor 15 operates as a slave device. For SPI data transfer purposes, processor 15 can be referred to as a slave processor, SPI slave, or other suitable term; and host 40 can be referred to as a host processor, a master, a SPI master, an external host, an external master, and/or any other suitable term.

SPI host port 50 includes a system master interface 52 and a system slave interface 54 connected to system interconnect 25. System master interface 52 enables processing system 10 to operate as a slave device so that host 40 (operating as a master device), can access resources of processing system 10. For example, system master interface 52 provides a master interface on system interconnect 25 having direct access to memory-mapped resources, such as memory and memory-mapped registers, of processing system 10. In various implementations, based on access commands received from host 40, system master interface 52 reads data from and/or writes data to memory-mapped resources of processing system 10 across system interconnect 25. In various implementations, system master interface 52 can perform prefetch operations. System slave interface 54 enables SPI host port 50 to operate as a slave device so that processing system 10 (operating as a master device) can access resources of SPI host port 50, such as memory and/or registers of SPI host port 50.

A SPI host port receive buffer (SPIHP_RFIFO) 56 can store data received from host 40, and a SPI host port transmit buffer (SPIHP_TFIFO) 58 can store data for transmission to host 40. In various implementations, SPI host port receive buffer 56 and SPI host port transmit buffer 58 are first-in-first-out buffers. SPI host port receive buffer 56 has an associated SPI host port receive shift register (RSR) 60, and SPI host port transmit buffer 58 has an associated SPI host port transmit shift register (TSR) 62.

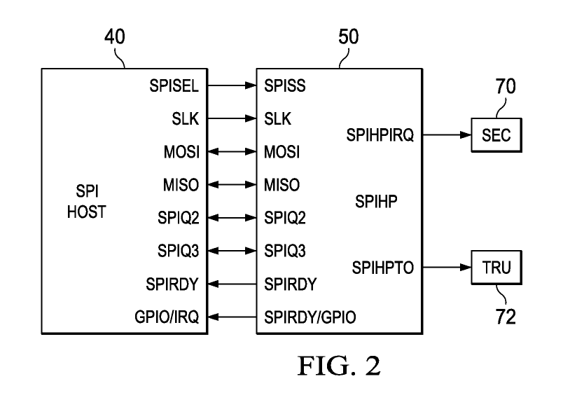

A SPI interface 64 provides a full-duplex, synchronous serial host interface for facilitating communication with host 40. SPI interface 64 has four data pins: a MOSI (master output, slave input) data pin, a MISO (master input, slave output), a SPIQ2 data pin and a SPIQ3 data pin. The four data pins enable SPI host port 50 to provide full-duplex operation and quad SPI operation. FIG. 2 is an exemplary master to slave connection model between host 40 (a SPI master) and SPI host port 50 (a SPI slave) according to various aspects of the present disclosure. In FIG. 2, SPI host port 50 supports the following SPI signals (and corresponding lines):
MOSI: a data signal between host 40 and SPI host port 50, generated by host 40 and received by SPI host port 50;
MISO: a data signal between host 40 and SPI host port 50, generated by SPI host port 50 and received by host 40;
SPIQ2: a data signal between host 40 and SPI host port 50, generated by host 40 and received by SPI host port 50;
SPIQ3: a data signal between host 40 and SPI host port 50, generated by SPI host port 50 and received by host 40;
SLK: a clock signal from host 40 to SPI host port 50, generated by host 40 and received by SPI host port 50 to synchronize data transfers between host 40 and SPI host port 50;
SPISEL: a SPI select signal from host 40 to SPI host port 50, generated by host 40 and received by SPI host port 50; and
SPIRDY: a SPI ready signal from SPI host port 50 to host 40, generated by SPI host port 50 and received by host 40.
   Host 40 enables SPI host port 50 through SPI select line. In the present example, SPI host port 50 functionality can be enabled when SPI host port 50 receives SPI select signal from host 40. Otherwise, SPI host port 50 may operate in a standby mode. During SPI data transfer, data is simultaneously transmitted (for example, shifted out serially) and received (for example, shifted in serially) on the data lines (MOSI, MISO, SPIQ2, and/or SPIQ3), and the clock line (SLK) synchronizes shifting and sampling of information on the data lines. Data transmitted on the data lines can include instructions, addresses, and data associated with access operations performed by host 40. Data bytes may be shifted out/in SPI host port 50 in a most significant byte first manner. In various implementations, SPI host port 50 can receive instructions (opcodes), addresses, and dummy bytes on MOSI data line, where instructions can begin on a falling edge of SPI select signal and end on a rising edge of SPI select signal.

SPI ready signal enables host 40 to control data transfer between processing system 10 and host 40 in a hardware manner, providing hardware flow control for host 40. SPI ready signal can indicate a need for host 40 to stall, such that host 40 can use SPI ready signal to perform access (read/write) operations on memory-mapped resources of processing system 10. For example, host 40 waits for SPI host port 50 to assert SPI ready signal to latch data during a read operation or send data during a write operation. SPI host port 50 can assert SPI ready signal when ready for an access operation, such as a read, a write, or a pre-fetch operation. SPI ready signal assertion can be controlled by a SPI host port control 68. SPI host port 50 can stall host 40 from performing an access operation by deasserting SPI ready signal, for example, when SPI host port receive buffer 56 is almost full during a write operation, SPI host port transmit buffer 58 is almost empty during a read operation, when SPI host port 50 detects an error condition, and/or when SPI host port 50 detects some other occurrence that warrants stalling host 40. Host 40 can thus use SPI ready signal as a throttle to delay subsequent data transfer and/or instructions as necessary until the slave device (processing system 10) is ready.

SPI host port 50 further supports a SPI host port interrupt request (SPIHPIRQ) signal and a SPI host port trigger out (SPIHPTO) signal from SPI host port 50 to components of processing system 10. In the depicted embodiment, SPI host port interrupt request signal is connected to a system event controller (SEC) 70 of processing system 10, which manages configuration of system event sources as well as propagation of system events and system interrupts in processing system 10. In various implementations, system event controller 70 manages system interrupt and/or system fault sources, including control features such as enable/disable, prioritization, and active/pending source status. In the depicted embodiment, SPI host port 50 provides SPI host port trigger out signal to system event controller 70 when an error condition is detected. SPI host port interrupt request signal can be controlled by SPI host port control 68, as described below.

SPI host port 50 further supports a SPI host port trigger out (SPIHPTO) signal from SPI host port 50 to components of processing system 10. In the depicted embodiment, SPI host port trigger out signal is connected to a trigger routing unit (TRU) 72 of processing system 10. Trigger routing unit 72 provide system-level sequence control for processing system without core intervention, for example, from processor 15. Trigger routing unit 72 can receive trigger inputs from master trigger inputs, and generate trigger outputs that initiate slave operations in processor 15 and peripherals of processing system 10 based on the trigger inputs. In the depicted embodiment, SPI host port 50 provides SPI host port trigger out signal as a master trigger input of trigger routing unit 72. SPI host port trigger out signal can be controlled by SPI host port control 68, as described below.

Returning to FIG. 1, SPI host port 50 provides slave support for host 40 to access memory-mapped resources, including memory and/or memory-mapped registers, of processing system 10 through a SPI memory command protocol. SPI memory command protocol generally refers to any SPI communication protocol used in SPI memory architectures (in other words, a memory that includes a SPI interface), such as SPI SRAM/Flash style protocols. SPI host port 50 is configured such that host 40 can use a software-driven or hardware-driven SPI memory command protocol to access memory-mapped resources. When in slave mode, SPI host port 50 expects and interprets instructions (also referred to as commands, operation codes, or opcodes) from host 40 and responds appropriately for each instruction supported by SPI host port 50. Each instruction can begin when host 40 asserts SPI select signal and end when host 40 deasserts SPI select signal. In various implementations, using SPI memory command protocol, SPI host port 50 can interpret an SPI communication packet received from host 40 into an access instruction that specifies an access operation and address/data information associated with the access operation, and then generate signaling necessary to perform the access operation (such as a read, a write, or a prefetch operation) on memory-mapped resources of processing system 10. The SPI communication packet can include a header and a payload, where SPI host port 50 can interpret the payload as a unique, particular access instruction and then perform an access operation based on the particular access instruction. For example, to perform a read operation, host 40 can send an SPI communication packet that includes a read data instruction along with associated address information. SPI host port 50 can store the SPI communication packet (for example, in SPI host port receive buffer 56), and interpret (decode) a payload of the SPI communication packet to identify the read data instruction and a read address. Based on the read data instruction and read address, SPI master interface 52 can read data from memory-mapped resources over system interconnect 25, and send the read data to host 40. System master interface 52 may store the read data in SPI host port transmit buffer 58 until transmitted to host 40. In various implementations, system master interface 52 can interpret the payload.

Table 1 provides SPI memory instructions/commands that can be supported by SPI host port 50, in various implementations. Each instruction has an associated SPI communication packet that includes an instruction/opcode byte (such as Byte 0) and various information bytes (such as Byte 1, Byte 2, Byte 3, Byte 4, and Byte 5). The instruction/opcode byte specifies a type of access operation, and the information bytes can be address bytes or data bytes depending on the access operation. In Table 1, “A” stands for address, “D” stands for data input to SPI host port 50, “(D)” stands for data output from SPI host port 50, “R” stands for a SPI host port register address, “S” stands for stride, and “Dummy” stands for an unused/discarded byte.

TABLE 1

| | Byte 0 | | | | | |
|---|---|---|---|---|---|---|
| Instruction | (Opcode) | Byte 1 | Byte 2 | Byte 3 | Byte 4 | Byte 5 |
| Read Data | 0x03 | A23:16 | A15:8 | A7:0 | D7:0 | — |
| Fast Read | 0x0B | A23:16 | A15:8 | A7:0 | Dummy | (D7:0) |
| Fast Read Dual Output | 0x3B | A23:16 | A15:8 | A7:0 | Dummy | (D7:0, . . . ) |
| Fast Read Quad Output | 0x6B | A23:16 | A15:8 | A7:0 | Dummy | (D7:0, . . . ) |
| Write Data | 0x02 | A23:16 | A15:8 | A7:0 | D7:0 | — |
| Write Data Dual Input | 0xA2 | A23:16 | A15:8 | A7:0 | Dummy | D7:0, . . . |
| Write Data Quad Input | 0x32 | A23:16 | A15:8 | A7:0 | Dummy | D7:0, . . . |
| Write Data Stride* | 0x0A | A23:16 | A15:8 | A7:0 | S7:0 | D7:0 |
| Write Data Dual Input Stride* | 0xAA | A23:16 | A15:8 | A7:0 | Dummy | S7:0, D7:0 |
| Write Data Quad Input Stride* | 0x3A | A23:16 | A15:8 | A7:0 | Dummy | S7:0, D7:0, . . . |
| Read Register* | 0x55 | R7:0 | Dummy | D7:0 | D15:8 | D23:16 |
| Read Register Dual Output* | 0x75 | R7:0 | Dummy | (D7:0, . . . ) | — | — |
| Read Register Quad Output* | 0x95 | R7:0 | Dummy | (D7:0, . . . ) | — | — |
| Write Register* | 0x11 | R7:0 | D7:0 | D15:8 | D23:16 | D31:24 |

SPI host port 50 can support host 40 accessing memory-mapped resources, such as memory and/or memory-mapped registers, of processing system 10. See, for example, Read Data, Fast Read, Fast Read Dual Output, Fast Read Quad Output, Write Data, Write Data Dual Input, and Write Data Quad Input instructions. SPI host port 50 can support host 40 accessing registers local to SPI host port 50 through dedicated register read and register write instructions. See, for example, Read Register, Read Register Dual Output, Read Register Quad Output, and Write Register. In some implementations, register read instructions can return data from least significant byte to most significant byte, and register write instructions can expect data from least significant byte to most significant byte. SPI host port 50 can further support host 40 performing write data stride. See, for example, Write Data Stride, Write Data Dual Input Stride, and Write Data Quad Input Stride. In various implementations, host 40 can write data to memory to discontinuous addresses using write data stride instructions. Such instructions may expect a stride byte value before each data element of the payload. Table 1 is not an exhaustive list of instructions supported by SPI host port 50, and as noted above, SPI host port 50 can support various instructions/commands/opcodes as applicable to SPI memory architectures, such as SPI flash/SRAM memory.

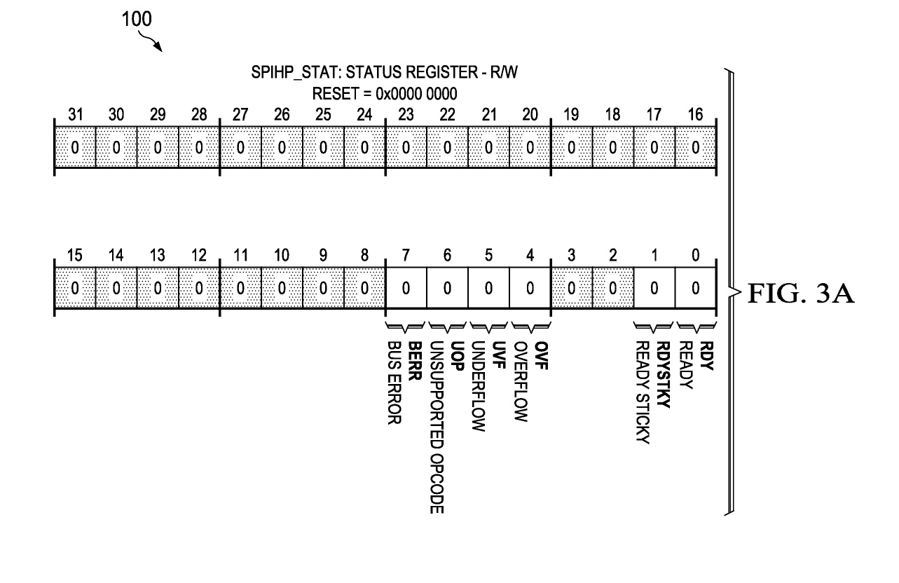

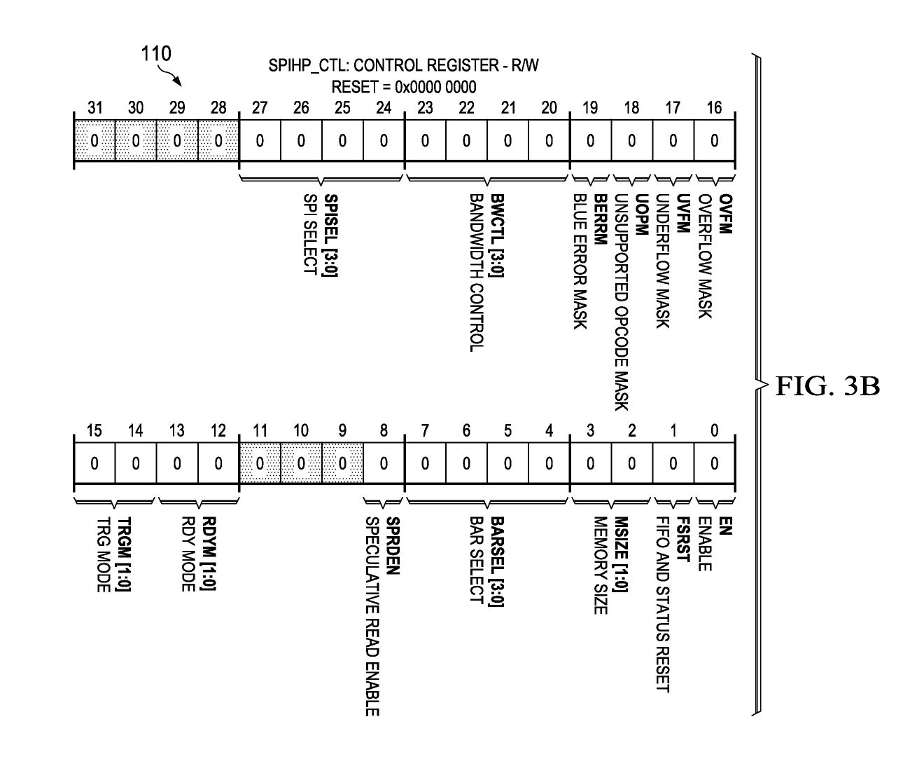

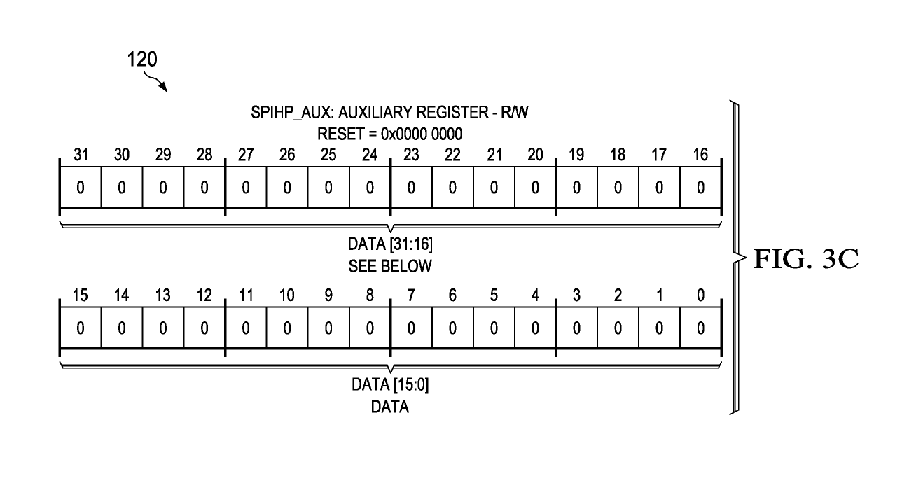

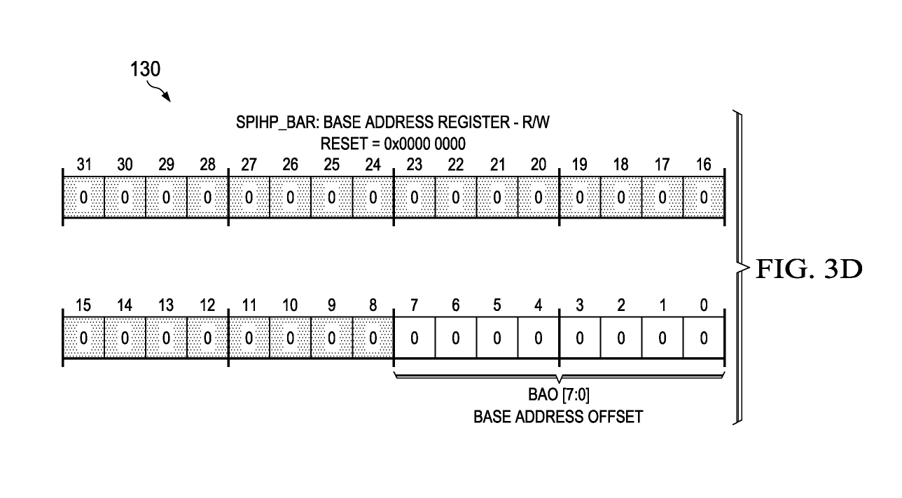

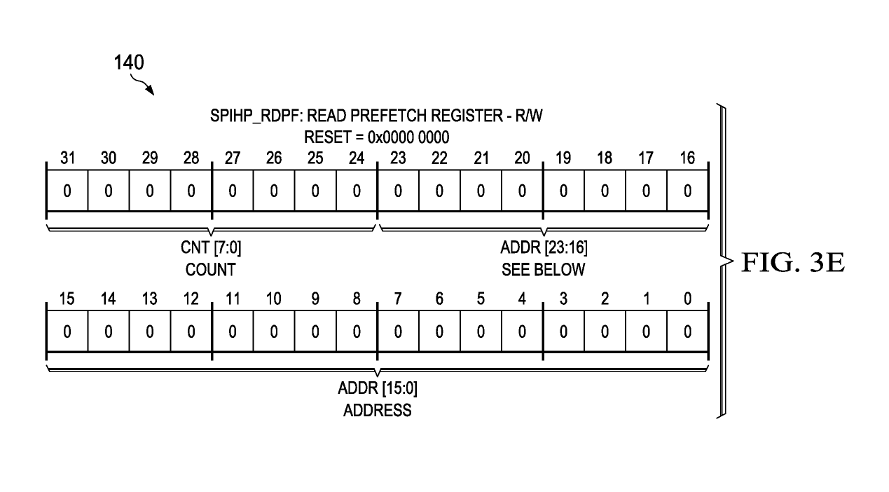

SPI host port control 68 governs operations of SPI host port 50, such that SPI host port 50 can achieve functionality as described herein. SPI host port control 68 can include SPI host port logic and various SPI host port registers. In various implementations, SPI host port logic and SPI host port registers determine transactions issued to system master interface 52. For example, based on instructions received from host 40, SPI host port control 68 can generate instructions to system master interface 52 for accessing memory-mapped resources. FIGS. 3A-3E depict exemplary SPI host port registers according to various aspects of the present disclosure. In the depicted embodiments, SPI host port registers are implemented as 32-bit SPI host port registers, though the present disclosure contemplates SPI host port registers of any size. FIG. 3A depicts a SPI host port status register 100 that provides status information associated with operation of SPI host port 50. FIG. 3B depicts a SPI host port control register 110 that provides control for operation of SPI host port 50. FIG. 3C depicts a SPI host port auxiliary register 120 that provides communication between SPI host port 50 and host 40. FIG. 3D depicts a SPI host port base address register 130 that provides address translation. FIG. 3E depicts a SPI host port read prefetch register 140 that provides information for pre-fetch operations. FIGS. 3A-3E have been simplified for the sake of clarity to better understand the inventive concepts of the present disclosure. Additional features can be added in the depicted SPI host port registers, and some of the features described can be replaced or eliminated in other embodiments of SPI host port registers.

In FIG. 3A, SPI host port status register 100 includes various bits that when triggered (for example, set to an active state) reflect error conditions associated with SPI host port 50. For example, SPI host port register 100 can include:
a bus error (SPIHP_STAT.BERR) bit that may be triggered by access response errors received for any transfer over system interconnect 25 (for example, when SPI host port 50 receives a slave error (SLVERR) signal or a decode error (DECERR) signal), misaligned address errors, payload errors, speculative read errors, or other bus-related error;
an unsupported opcode (SPIHP_STAT.UOP) bit that may be triggered when host 40 initiates a read that underflows SPI host port transmit buffer 58;
an underflow (SPIHP_STAT.UVF) bit that may be triggered when host 4 initiates a write that overflows SPI host port receive buffer 56; and
an overflow (SPI_STAT.OVF) bit that may be triggered when host 40 initiates a command/opcode that is invalid or unsupported by SPI host port 50, including access violations associated with local read/write register instructions.
   In some implementations, bus error bit, unsupported opcode bit, underflow bit, and overflow bit can be implemented as W1C (write-1-to-clear) bits.

SPI host port status register 100 further includes a SPI host port status ready (SPIHP_STAT.RDY) bit that indicates when SPI host port 50 is ready for an access operation, such as a read data, a write data, or a prefetch instructions operation. Host 40 cannot perform an access operation when SPI host port status ready bit reflects an inactive state. SPI host port status ready bit may be transitioned to an inactive state (deasserted) under various conditions, including but not limited to, when SPI host port receive buffer 56 is almost full during a write data instruction, when SPI host port transmit buffer 58 is almost empty during a read data instruction, or when any error condition bit is triggered. In various implementations, SPI host port status register 100 can further includes a SPI host port status ready sticky (SPIHP_STAT.RDYSTKY) bit that indicates when SPI host port 50 is ready for an access operation, which can be triggered when SPI host port 50 asserts SPI host port status ready bit. In some implementations, SPI host port status ready bit can be implemented as a not write-through bit (NW), and SPI host port status ready sticky bit can be implemented as W1C (write-1-to-clear) bits. Accordingly, as described above, host 40 may wait for SPI host port 50 to assert SPI host port status ready bit (or SPI host port status ready sticky bit, depending on how SPI host port 50 is configured) before performing an access operation.

SPI host port status register 100 enable host 40 to control data transfer between processing system 10 and host 40 in a software manner, providing software flow control for host 40. Software flow control is managed by checking a status of SPI host port 50 before read/write operations and using prefetch operations to perform reads from SPI slave memory space. In various implementations, host 40 can place a limit on a data transfer size and check SPI host port status register 100 after each instruction completion (read data, write data, or prefetch operation) to confirm a previous operation and before performing a next operation. For example, for write data operations, host 40 can limit write data instruction payloads to a depth of SPI host port receive buffer 56. After each write data instruction, host 40 can check SPI host port status ready bit to confirm that SPI host port 50 is ready for a next operation.

In FIG. 3B, SPI host port control register 110 includes various bits control operation of SPI host port 50, including but not limited to, the following control bits:
a SPI host port enable (SPIHP_CTL.EN) bit that controls a functional state of SPI host port 50, enabling SPI host port 50 when set to an active state;
a SPI host port buffer and status reset (SPIHP_CTL.FSRST) bit for resetting a status of SPI host port 50, including SPI host port receive buffer 56 and SPI host port transmit buffer 58;
a SPI host port memory size (SPIHP_CTL.MSIZE) bit field that controls a transfer size for system master interface 52 when performing access operations, including read data, write data, and prefetch operations;
a SPI host port base address register select (SPIHP_CTL.BARSEL) bit field that selects a base address register for SPI host port 50 to use for address translation;
a SPI host port speculative read enable (SPIHP_CTL.SPRDEN) bit that enables system master interface 52 to perform speculative reads beyond a current address to avoid interrupted flow of read data, where any read data operations performed by system master interface 52 may be limited to a memory size specified by SPI host port memory size bit field;
a SPI host port ready mode (SPIHP_CTL.RDYM) bit field that controls a source for SPI ready signal from SPI host port 50 to host 40;
a SPI select (SPIHP_CTL.SPISEL) bit field selects a serial peripheral interface used for a physical interface for establishing a connection between SPI host port 50 and host 40; and
a SPI host port bandwidth control (SPIHP_CTL.BWCTL) bit field sets a limit for a total number of outstanding transactions allowed by system master interface 52.
   In various implementations, SPI host port speculative read enable bit can be sued for memory regions to improve performance and avoid underflow and/or SPI ready signal deassertion. It is noted that any read data operations that attempt to access more than a transfer size defined by SPI host port memory size bit field can result in bus error bit (supported by SPI host port status register 100) being set. In the depicted embodiment, SPI host port ready mode bit field includes a ready bit and a ready sticky bit, where SPI ready signal from SPI host port 50 to host 40 will reflect a state of SPI host port status ready bit (supported by SPI host port status register 100) when ready bit is enabled or a state of SPI host port status ready sticky bit (supported by SPI host port status register 100) when ready sticky bit is enabled. Other sources can be defined in SPI host port ready mode bit field, where SPI ready signal from SPI host port 50 to host 40 will reflect a state of the other sources when their corresponding bits are enabled.

SPI host port control register 110 can further include various bits for enabling SPI host port interrupt request signal and SPI host port trigger out signal from SPI host port 50 to resources of processing system 10. In the depicted embodiment, SPI host port control register 110 includes various masks that control assertion of SPI host port interrupt signal (for example, from SPI host port 50 to system event controller 70):
a bus error mask (SPIHP_CTL.BERRM) bit that controls whether a status of bus error bit (supported by SPI host port status register 100) will assert SPI host port interrupt request signal;
an unsupported opcode mask (SPIHP_CTL.UOPM) bit that controls whether a status of unsupported opcode bit (supported by SPI host port status register 100) will assert SPI host port interrupt request signal;
an underflow mask (SPIHP_CTL.UVFM) bit that controls whether a status of underflow bit (supported by SPI host port status register 100) will assert SPI host port interrupt request signal; and
an overflow mask (SPIHP_CTL.OVFM) bit that controls whether a status of overflow bit (supported by SPI host port status register 100) will assert SPI host port interrupt request signal.
   For example, when SPI host port 50 enables bus error mask bit, SPI host port 50 will assert SPI host port interrupt request signal to SEC 70 when bus error bit is triggered by a bus-related error. Similarly, when SPI host port 50 enables unsupported opcode mask bit, underflow mask bit, and/or overflow mask bit, SPI host port 50 will assert SPI host port interrupt request signal when the mask bits corresponding unsupported opcode bit, underflow bit, and overflow bit is triggered as described above. In furtherance of the depicted embodiment, SPI host port control register 110 includes:
a trigger mode (SPIHP_CTL.TRGM) bit field that controls a source for asserting SPI host port trigger out signal (for example, from SPI host port 50 to trigger routing unit 72).
   In the depicted embodiment, trigger mode bit field includes a ready sticky bit, where SPI host port trigger out signal from SPI host port 50 to trigger routing unit 72 will reflect a state of SPI host port status ready sticky bit (supported by SPI host port status register 100) when ready sticky bit is enabled. Other sources can be defined in trigger mode bit field, where SPI host port trigger out signal from SPI host port 50 to trigger routing unit 72 will reflect a state of the other sources when their corresponding bits are enabled.

In FIG. 3C, SPI host port auxiliary register 120 is a software definable register that includes various data bits for conveying information between SPI host port 50 and host 40. In some implementations, SPI host port auxiliary register can be used for message passing, identification, or other purposes depending on design and application considerations. SPI host port register set may include multiple SPI host port auxiliary registers. In FIG. 3D, SPI host port base address register 130 provides a base address offset (BAO) that can be pre-pended to an address supplied by host 40 to SPI host port 50, facilitating unconstrained access to a memory space of processing system 10. A base address offset (SPIHP_BAR[n].BAO) bit field defines a base address offset to pre-pend to an address supplied by host 40. A base address offset value of can be used as other bits of SPI host port base address register 130 for a local address. In the depicted embodiment, SPI base address register 130 provides for an 8-bit address offset, though other address offsets are contemplated by the present disclosure. A SPI host port register set may include multiple SPI host port base address registers. In such implementations, host 40 selects SPI host port base address register 130 using SPI host port base address register select bit field (supported by SPI host port control register 110), such that host 40 can quickly switch SPI host port base address registers. Host 40, SPI host port 50, or other resource of processing system 10 can configure values of SPI host port base address registers before operation, and host 40 can switch pages by writing to SPI host port base address register select bit field to select a desired SPI host port base register.

In FIG. 3E, SPI host port read prefetch register 140 includes various bits that provide information about prefetch operations that can be performed by SPI host port 50. SPI host port read prefetch register 140 includes:
a count (SPIHP_RDPF.CNT) bit field that specifies a transfer count for a prefetch operation; and
an address (SPIHP)RDPF.ADDR) bit field that specifies an address target for the prefetch operation.
   In the depicted embodiment, SPI host port read prefetch register 140 holds a 24-bit address and an 8-bit transfer count for read prefetching. It is noted that, where count bit field specifies a transfer count of N and SPI host port memory size bit field (supported by SPI host port control register 110) specifies that a transfer size for system master interface 52 of M, system master interface 52 can read NxM bytes from consecutive locations and write them to SPI host port transmit buffer 58. The locations can begin at an address specified by base address offset bit field (supported by SPI base address register 130). In some implementations, software flow control for host 40 provided by SPI host port status register 100 may suffer from a high probability of read underflow error resulting from variable and potentially large latency, which can arise from system topology, system traffic, clock domain crossings, and/or other issues. To minimize (or eliminate) such issues, SPI host port 50 can provide read prefetch support using SPI host port read prefetch register 140. SPI host port read prefetch support can prime SPI host port transmit buffer 58 with data that host 40 wants to read. Host 40 can initially write to SPI host port read prefetch register 140 to initiate a prefetch operation by system master interface 52, and then poll SPI host port status ready bit (or SPI host port status ready sticky bit) to determine when it is safe to read from SPI host port transmit buffer 58.

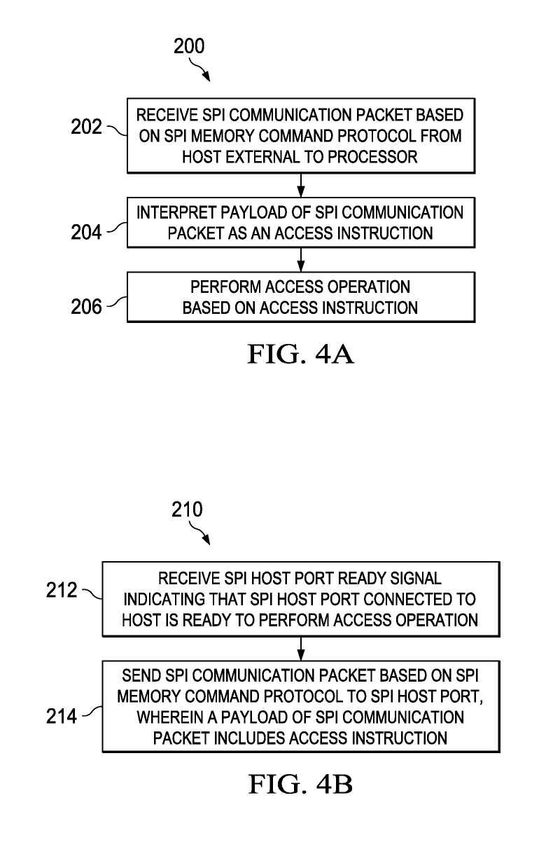

FIG. 4A is a flowchart of an exemplary method 200 that can be performed by a SPI to enable a host external to a processor to access memory-mapped resources according to various aspects of the present disclosure. In various implementations, SPI host port 50 can implement method 200. At block 202, a SPI communication packet based on a SPI memory command protocol is received from a host external to a processor. At block 204, a payload of the SPI communication packet is interpreted as an access instruction. At block 206, an access operation is performed based on the access instruction. Additional steps can be provided before, during, and after method 200 and some of the steps described can be replaced or eliminated for other embodiments of method 200.

FIG. 4B is a flowchart of an exemplary method 210 that can be performed by a host external to a processor to access memory-mapped resources according to various aspects of the present disclosure. In various implementations, host 40 can implement method 210. At block 210, a SPI host port ready signal is received indicating that an SPI host port connected to a host is ready to perform an access operation. At block 212, a SPI communication packet based on a SPI memory command protocol is sent to the SPI host port, where a payload of the SPI communication packet includes an access instruction. Additional steps can be provided before, during, and after method 210 and some of the steps described can be replaced or eliminated for other embodiments of method 210.

In various implementations, processing system 10, components of processing system 10 (such as processor 15, memory 20, SPI host port 50), and/or the various circuits and/or components of the FIGURES can be implemented on a board of an associated electronic device. The board can be a general circuit board that can hold various components of an internal electronic system of the electronic device and, further, provide connectors for other peripherals. The board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, other considerations, or a combination thereof. Other components, such as external storage, sensors, controllers for audio/video display, and peripheral devices may be attached to the board as plug-in cards, via cables, or integrated into the board itself. In various implementations, processing system 10, components of processing system 10, and/or the various the circuits and/or components of the FIGURES can be implemented as stand-alone modules (for example, a device with associated components and circuitry configured to perform a specific application or function) or implemented as plug-in modules into application specific hardware of electronic devices. Note that particular embodiments of the present disclosure may be readily included in a system-on-chip (SOC) package, either in part, or in whole. An SOC represents an integrated circuit that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the various functions described herein may be implemented in one or more semiconductor cores (such as silicon cores) in application specific integrated circuits (ASICs), field programmable gate arrays (FPGAs), other semiconductor chips, or combinations thereof.

The various functions outlined herein may be implemented by logic encoded in one or more non-transitory and/or tangible media (for example, embedded logic provided in an application specific integrated circuit (ASIC), as digital signal processor (DSP) instructions, software (potentially inclusive of object code and source code) to be executed by a processor, or other similar machine, etc.). In some of these instances, a memory element can store data used for the operations described herein. This includes the memory element being able to store logic (for example, software, code, processor instructions) that is executed by a processor to carry out the activities described herein. The processor can execute any type of instructions associated with the data to achieve the operations detailed herein. In various implementations, the processor can transform an element or an article (such as data) from one state or thing to another state or thing. In another example, the activities outlined herein may be implemented with fixed logic or programmable logic (such as software/computer instructions executed by the processor) and the elements identified herein can be some type of a programmable processor (such as a DSP), programmable digital logic (e.g., a FPGA, an erasable programmable read only memory (EPROM), an electrically erasable programmable ROM (EEPROM)), or an ASIC that includes digital logic, software, code, electronic instructions, or any suitable combination thereof.

Note that the activities discussed above with reference to the FIGURES are applicable to any integrated circuits that involve signal processing, particularly those that can execute specialized software programs or algorithms, some of which may be associated with processing digitized real-time data. Certain embodiments can relate to multi-DSP signal processing, floating point processing, signal/control processing, fixed-function processing, microcontroller applications, etc. In certain contexts, the features discussed herein can be applicable to medical systems, scientific instrumentation, wireless and wired communications, radar, industrial process control, audio and video equipment, current sensing, instrumentation (which can be highly precise), and other digital-processing-based systems. Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind) Furthermore, powertrain systems (for example, in hybrid and electric vehicles) can use high-precision data conversion products in battery monitoring, control systems, reporting controls, maintenance activities, etc. In yet other example scenarios, the teachings of the present disclosure can be applicable in the industrial markets that include process control systems that help drive productivity, energy efficiency, and reliability. In consumer applications, the teachings of the signal processing circuits discussed above can be used for image processing, auto focus, and image stabilization (e.g., for digital still cameras, camcorders, etc.). Other consumer applications can include audio and video processors for home theater systems, DVD recorders, and high-definition televisions. Yet other consumer applications can involve advanced touch screen controllers (e.g., for any type of portable media device). Hence, such technologies could readily be a part of smartphones, tablets, security systems, PCs, gaming technologies, virtual reality, simulation training, etc.

The specifications, dimensions, and relationships outlined herein have only been offered for purposes of example and teaching only. Each of these may be varied considerably without departing from the spirit of the present disclosure, or the scope of the appended claims. The specifications apply only to non-limiting examples and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than a restrictive sense.

Note that with the numerous examples provided herein, interaction may be described in terms of two, three, four, or more processing components. However, this has been done for purposes of clarity and example only. It should be appreciated that the system can be consolidated in any suitable manner. Along similar design alternatives, any of the illustrated components, modules, circuits, and elements of the FIGURES may be combined in various possible configurations, all of which are clearly within the broad scope of this Specification. In certain cases, it may be easier to describe one or more of the functionalities of a given set of flows by only referencing a limited number of processing components. It should be appreciated that the processing components of the FIGURES and its teachings are readily scalable and can accommodate a large number of components, as well as more complicated/sophisticated arrangements and configurations. Accordingly, the examples provided should not limit the scope or inhibit the broad teachings of the processing system and/or components as potentially applied to a myriad of other architectures.

Further, note that references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. It is further noted that “coupled to” and “coupled with” are used interchangeably herein, and that references to a feature “coupled to” or “coupled with” another feature include any communicative coupling means, electrical coupling means, mechanical coupling means, other coupling means, or a combination thereof that facilitates the feature functionalities and operations, such as the security check mechanisms, described herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

### OTHER NOTES, EXAMPLES, AND IMPLEMENTATIONS

In various implementations, a system is provided. The system can include means for receiving a SPI communication packet based on a SPI memory command protocol from a host external to a processor; interpreting a payload of the SPI communication packet as an access instruction; and performing an access operation based on the access instruction. The ‘means for’ in these instances can include (but is not limited to) using any suitable component discussed herein, along with any suitable software, circuitry, hub, computer code, logic, algorithms, hardware, controller, interface, link, bus, communication pathway, etc. In various implementations, the system includes memory that includes instructions that when executed cause the system to perform any of the activities discussed herein.

What is claimed is:

1. A processor comprising:
a system interconnect connected to memory-mapped resources; and
a serial peripheral interface (SPI) host port connected to the system interconnect, wherein the SPI host port is configured to use an SPI memory command protocol to access memory-mapped resources of the processor for a host external to the processor.

2. The processor of claim 1, wherein the SPI host port includes a system master interface connected to the system interconnect, wherein the system master interface is configured to access the memory-mapped resources across the system interconnect based on an instruction received from the host external to the processor.

3. The processor of claim 1, wherein the SPI host port is configured to interpret a payload of an SPI communication packet received from the host as an access instruction and perform an access operation based on the access instruction, wherein the SPI communication packet is based on the SPI memory command protocol.

4. The processor of claim 1, wherein the SPI host port includes a SPI host port ready line for asserting an SPI host port ready signal to the host when the SPI host port is ready to perform an access operation.

5. The processor of claim 1, wherein the SPI host port includes a SPI host port status register that includes a SPI host port status ready bit that indicates when the SPI host port is ready to perform an access operation.

6. The processor of claim 1, wherein the SPI host port status register includes an error condition bit that indicates an error condition.

7. The processor of claim 1, wherein the SPI host port includes a SPI host port interrupt request line for asserting a SPI host port interrupt request signal when the SPI host port detects an error condition.

8. The processor of claim 7, further comprising a system event controller, wherein the SPI host port interrupt request line is connected to the system event controller.

9. The processor of claim 7, wherein the SPI host port includes a SPI host port control register that includes an error condition mask bit for controlling assertion of the SPI host port interrupt request signal.

10. The processor of claim 1, wherein the SPI host port includes a SPI host port trigger out line for asserting a SPI host port trigger out signal when the SPI host port is ready to perform an access operation.

11. The processor of claim 10, further comprising a trigger routing unit, wherein the SPI host port trigger out line is connected to the trigger routing unit.

12. The processor of claim 10, wherein the SPI host port includes a SPI host port control register that includes a trigger mode bit for controlling a source for asserting the SPI host port trigger out signal.

13. The processor of claim 1, wherein the SPI memory command protocol is a SPI SRAM/Flash style protocol.

14. A method to be performed by a serial peripheral interface (SPI) host port to facilitate access to memory-mapped resources of a processor, the method comprising:
receiving an SPI communication packet based on a SPI memory command protocol from a host external to the processor;
interpreting a payload of the SPI communication packet as an access instruction; and
performing an access operation based on the access instruction.

15. The method of claim 14, further comprising asserting an SPI host port ready signal to the host when the SPI host port is ready to perform the access operation.

16. The method of claim 14, further comprising asserting an SPI host port status ready bit when the SPI host port is ready to perform the access operation.

17. The method of claim 14, further comprising asserting a SPI host port interrupt request signal when the SPI host port detects an error condition.

18. The method of claim 14, further comprising asserting a SPI host port trigger out signal when the SPI host port is ready to perform the access operation.

19. A serial peripheral interface (SPI) comprising:
a serial peripheral interface (SPI) host port configured to interpret a payload of an SPI communication packet based on an SPI memory command protocol received from a host external to a processor as an access instruction and access memory-mapped resources of the processor for the host based on the access instruction.

20. The SPI of claim 19, wherein the SPI host port includes:
a SPI host port ready line for asserting an SPI host port ready signal to the host when the SPI host port is ready to perform an access operation; and
a SPI host port status register that includes a SPI host port status ready bit that indicates when the SPI host port is ready to perform an access operation.
